(19) United States
(12) Patent Application Publication
(10) Pub. No.: US 2017/0003433 A1
(43) Pub. Date: Jan. 5, 2017

(54) LIGHT GUIDING PLATE, EDGE-LIT BACKLIGHT MODULE AND LIQUID CRYSTAL DISPLAY DEVICE

(71) Applicant: SHENZHEN CHINA STAR OPTOELECTRONICS TECHNOLOGY CO., LTD., Shenzhen (CN)

(72) Inventor: Jianyu CHANG, Shenzhen (CN)

(21) Appl. No.: 14/440,100

(22) PCT Filed: May 12, 2014
(86) PCT No.: PCT/CN2014/077260

§ 371 Date: May 1, 2015

(30) Foreign Application Priority Data
Mar. 27, 2014 (CN) 201410118198.3

(51) Int. Cl. F21V 8/00

(52) U.S. Cl. CPC G02B 6/0038; G02B 6/0055

(57) ABSTRACT

The present invention discloses a light guiding plate, an edge-lit backlight module and a liquid crystal display device. The light guiding plate comprises a main body and multiple pairs of grooves arranged along the bottom surface of the main body, each pair of grooves comprises a first groove and a second groove. The first groove and the second groove are arranged symmetrically about the normal line of the light guiding plate. According to the light guiding plate, the light-extraction amount of the light guiding plate along the front view direction can be improved.

### FIELD OF THE INVENTION

The invention relates to a light guiding plate, an edge-lit backlight module and a liquid crystal display device.

### BACKGROUND OF THE INVENTION

Currently, there are mainly two types backlight module, i.e. direct type backlight module and edge-lit backlight module. Typically, an edge-lit backlight module comprises a light source such as LED light source, a light guide plate, optical films and reflection sheets.

Although the utilization efficiency of light can be improved by disposing optical films on the illuminating surface of the light guide plate, the whole thickness of backlight module will accordingly increases. When the amount of the optical films increases, the assembly of the backlight module becomes difficult and the cost of backlight module increases.

### SUMMARY OF THE INVENTION

The present invention provides a light guiding plate, which can improve the light-extraction amount of the light guiding plate along the front view direction.

The present invention is realized in such a way that: A light guiding plate, wherein the light guiding plate comprises a main body and multiple pairs of grooves arranged along the bottom surface of the main body, each pair of grooves comprises a first groove and a second groove, the first groove and the second groove are arranged symmetrically about the normal line of the light guiding plate.

Preferably, the light guiding plate comprises a mesh pattern disposed on the bottom surface of the main body between adjacent pairs of grooves.

Preferably, in the direction apart from the light source, the pitches between adjacent pairs of grooves gradually decrease.

Preferably, in the direction apart from the light source, the extending lengths of each pair of grooves gradually increase.

Preferably, the angle formed between the first groove and the bottom surface of the main body is between 30° and 60°.

Preferably, the pitches between adjacent pairs of grooves are different from each other and/or the extending heights of each pairs of grooves are different from each other.

According to another aspect of the present invention, there is provided an edge-lit backlight module, the edge-lit backlight module comprising a light source, a reflection sheet, and a light guiding plate, wherein, the light source is located at the side portion of the light guiding plate, the reflection sheet is located on the bottom surface of the light guiding plate, the light guiding plate comprises a main body and multiple pairs of grooves arranged along the bottom surface of the main body, each pair of grooves comprises a first groove and a second groove, the first groove and the second groove are arranged symmetrically about the normal line of the light guiding plate.

Preferably, the light guiding plate comprises a mesh pattern disposed on the bottom surface of the main body between adjacent pairs of grooves.

Preferably, in the direction apart from the light source, the pitches between adjacent pairs of grooves gradually decreases, the angle formed between the first groove and the bottom surface of the main body is between 30° and 60°.

Preferably, in the direction apart from the light source, the extending lengths of each pair of grooves gradually increase.

Preferably, the angle formed between the first groove and the bottom surface of the main body is between 30° and 60°.

Preferably, the pitches between adjacent pairs of grooves are different from each other and/or the extending heights of each pairs of grooves are different from each other.

According to yet another aspect of the present invention, there is provided a liquid crystal display device, the liquid crystal display device comprises the above-mentioned edge-lit backlight module.

According to the present invention, the light guiding plate comprises a main body and multiple pairs of grooves arranged along the bottom surface of the main body, each pair of grooves comprises a first groove and a second groove, the first groove and the second groove are arranged symmetrically about the normal line of the light guiding plate. By this way, the light-extraction amount of the light guiding plate along the front view direction can be improved, and the uniformity of light also can be improved.

For more clearly and easily understanding above content of the present invention, the following text will take a preferred embodiment of the present invention with reference to the accompanying drawings for detail description as follows.

### BRIEF DESCRIPTION OF THE DRAWINGS

The drawings described herein are for illustration purposes only and are not intended to limit the scope of the present disclosure in any way.

FIG. 1 is a schematic view showing the working status of the light guiding plate according to the first embodiment of the present invention;

FIG. 2 is a schematic view showing the working status of the light guiding plate according to the second embodiment of the present invention; and

FIG. 3 is a schematic view showing the working status of the edge-lit backlight module according to an embodiment of the present invention.

### DETAILED DESCRIPTION OF THE PREFERRED EMBODIMENTS

The embodiments of the present invention will be described in detail with reference to the accompanying drawings.

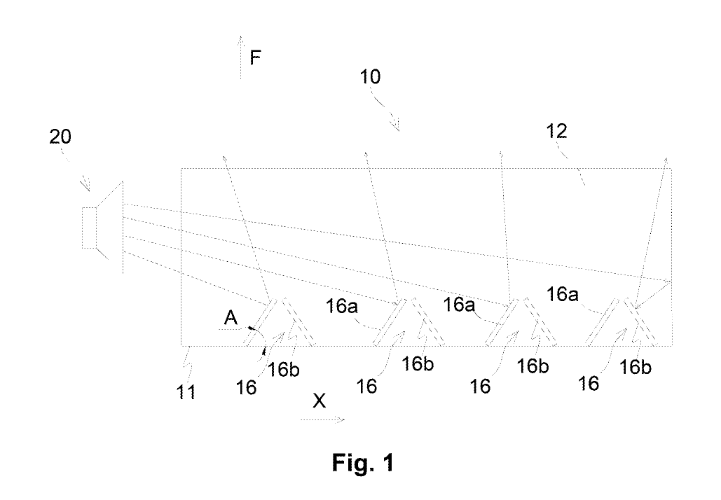

As shown in FIG. 1 to FIG. 3, the light guiding plate 10 comprises a main body 12 and multiple pairs of grooves 16. Said multiple pairs of grooves 16 are arranged along the bottom surface 11 of the main body 12.Wherein, each pair of grooves 16 comprises a first groove 16a and a second groove 16b. Moreover, the first groove 16a and the second groove 16b are arranged symmetrically about the normal line F of the light guiding plate 10. The normal line F of the light guiding plate 10 is parallel with the front view direction. The first groove 16a and the second groove 16b may be formed by laser, hot pressing or mechanical cutting process.

According to the light guiding plate 10 in the present embodiment, the light from the light source 20 are reflected to the illuminating surface of the light guide plate 10 by the first groove 16a and the second groove 16b, the light-extraction amount of the light guiding plate along the front view direction can be improved. Also, the amount of the optical films and prisms may be reduced.

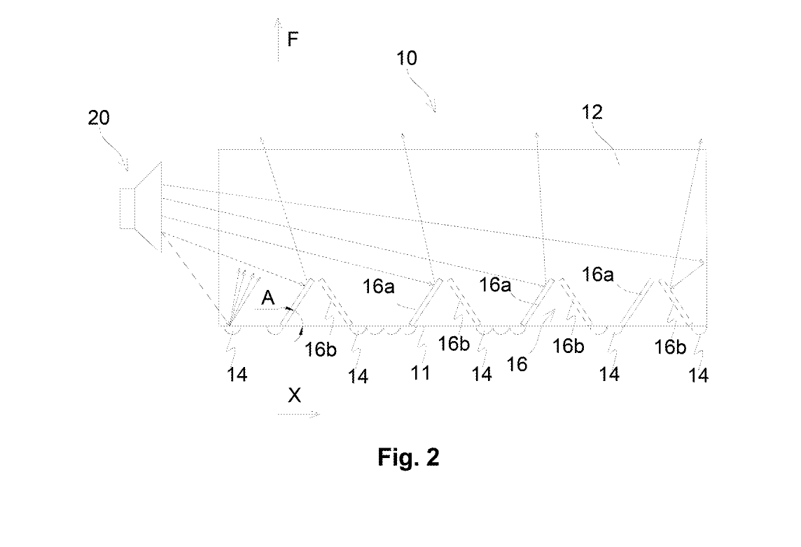

In the embodiment shown in FIG. 1, there is no mesh pattern disposed on the bottom surface 11 of the main body 12 between adjacent pairs of grooves. In the embodiment shown in FIG. 2, the light guiding plate 10 comprises a mesh pattern 14 disposed on the bottom surface 11 of the main body 12 between adjacent pairs of grooves 16. By disposing the mesh pattern 14, the light-extraction amount of the light guiding plate 10 along the front view direction can be further improved.

In some embodiments according to the invention, in the direction X apart from the light source 20, the pitches between adjacent pairs of grooves 16 are different from each other and/or the extending heights of each pairs of grooves 16 are different from each other.

In the embodiment shown in FIG. 1 to FIG. 3, in the direction X apart from the light source 20, the pitches between adjacent pairs of grooves 16 gradually decrease (i.e. the pitches between adjacent pairs of grooves 16 are different from each other).As shown in FIG. 2, in the direction X apart from the light source 20, the extending lengths of each pair of grooves (including the first groove 16a and the second groove 16b) gradually increase(i.e. the extending heights of each pairs of grooves 16 are different from each other).

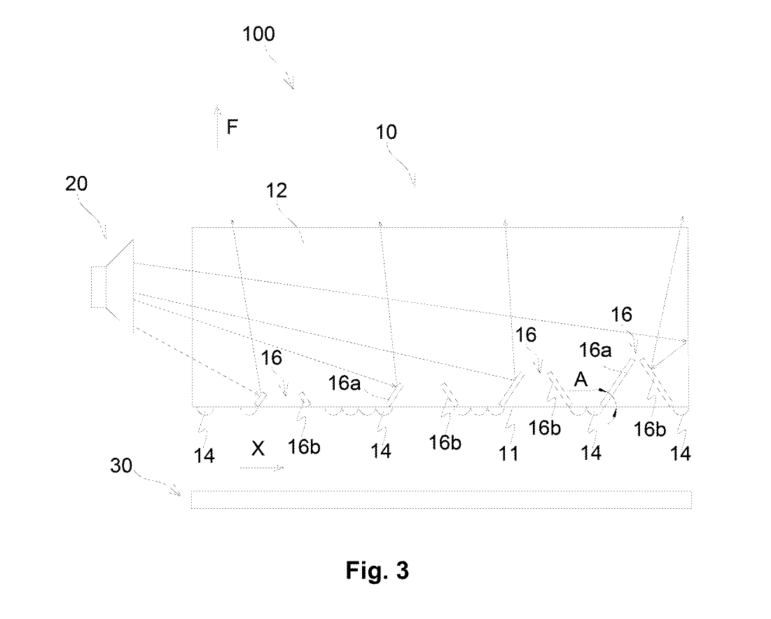

As shown in FIG. 3, the angle A formed between the first groove 16a and the bottom surface 11 of the main body 12 is between 30° and 60°. Preferably, the angle A formed between the first groove 16a and the bottom surface 11 of the main body 12 is 45°.

As shown in FIG. 3, the edge-lit backlight module 100 according to the present invention comprises a light source 20, a reflection sheet 30, and a light guiding plate 10.The light source 20 is located at the side portion of the light guiding plate 10. The reflection sheet 30 is located on the bottom surface 11 of the light guiding plate 10. The light guiding plate 10 is the above-mentioned light guiding plate 10 shown in FIG. 1 to FIG. 3.

According to yet another aspect of the present invention there is provided a liquid crystal display device. The liquid crystal display device comprises the above-mentioned edge-lit backlight module,

In the present invention, the light guiding plate 10 comprises a main body 12 and multiple pairs of grooves 16. Each pair of grooves 16 comprises a first groove 16a and a second groove 16b. The first groove 16a and the second groove 16b are formed on the bottom surface 11 of the main body 12 by laser, hot pressing or mechanical cutting process. By this way, the light-extraction amount of the light guiding plate along the front view direction can be improved, and the uniformity of light also can be improved. By reducing the amount of the optical films and prisms, the assembly of the backlight module becomes easy; the whole thickness of backlight module may be reduced.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A light guiding plate, comprising a main body and multiple pairs of grooves arranged along the bottom surface of the main body, wherein each pair of grooves comprises a first groove and a second groove, the first groove and the second groove are arranged symmetrically about the normal line of the light guiding plate.

2. The light guiding plate of claim 1, wherein the light guiding plate comprises a mesh pattern disposed on the bottom surface of the main body between adjacent pairs of grooves.

3. The light guiding plate of claim 1, wherein in the direction apart from the light source, the pitches between adjacent pairs of grooves gradually decrease.

4. The light guiding plate of claim 1, wherein in the direction apart from the light source, the extending lengths of each pair of grooves gradually increase.

5. The light guiding plate of claim 1, wherein the angle formed between the first groove and the bottom surface of the main body is between 30° and 60°.

6. The light guiding plate of claim 1, wherein the pitches between adjacent pairs of grooves are different from each other and/or the extending heights of each pairs of grooves are different from each other.

7. An edge-lit backlight module, comprising a light source, a reflection sheet, and a light guiding plate, wherein, the light source is located at the side portion of the light guiding plate, the reflection sheet is located on the bottom surface of the light guiding plate, the light guiding plate comprises a main body and multiple pairs of grooves arranged along the bottom surface of the main body, each pair of grooves comprises a first groove and a second groove, the first groove and the second groove are arranged symmetrically about the normal line of the light guiding plate.

8. The edge-lit backlight module of claim 7, wherein the light guiding plate comprises a mesh pattern disposed on the bottom surface of the main body between adjacent pairs of grooves.

9. The edge-lit backlight module of claim 7, wherein in the direction apart from the light source, the pitches between adjacent pairs of grooves gradually decreases, the angle formed between the first groove and the bottom surface of the main body is between 30° and 60°.

10. The edge-lit backlight module of claim 7, wherein in the direction apart from the light source, the extending lengths of each pair of grooves gradually increase.

11. The edge-lit backlight module of claim 7, wherein the angle formed between the first groove and the bottom surface of the main body is between 30° and 60°.

12. The edge-lit backlight module of claim 7, wherein the pitches between adjacent pairs of grooves are different from each other and/or the extending heights of each pairs of grooves are different from each other.

13. A liquid crystal display device, comprising an edge-lit backlight module, the edge-lit backlight module comprising a light source, a reflection sheet, and a light guiding plate, wherein, the light source is located at the side portion of the light guiding plate, the reflection sheet is located at the bottom surface of the light guiding plate, the light guiding plate comprises a main body and multiple pairs of grooves arranged along the bottom surface of the main body, each pair of grooves comprises a first groove and a second groove, the first groove and the second groove are arranged symmetrically about the normal line of the light guiding plate.

14. The liquid crystal display device of claim 13, wherein the light guiding plate comprises a mesh pattern disposed on the bottom surface of the main body between adjacent pairs of grooves.

15. The liquid crystal display device of claim 13, wherein in the direction apart from the light source, the pitches between adjacent pairs of grooves gradually decrease, the angle formed between the first groove and the bottom surface of the main body is between 30° and 60°.

16. The liquid crystal display device of claim 13, wherein in the direction apart from the light source, the extending lengths of each pair of grooves gradually increase.

17. The liquid crystal display device of claim 13, wherein the angle formed between the first groove and the bottom surface of the main body is between 30° and 60°.

18. The liquid crystal display device of claim 13, wherein the pitches between adjacent pairs of grooves are different from each other and/or the extending heights of each pairs of grooves are different from each other.
